(19) United States
(12) Patent Application Publication
(10) Pub. No.: US 2021/0253344 A1
(43) Pub. Date: Aug. 19, 2021

(54) GARBAGE COLLECTION CONTAINER WITH BUILT-IN DRAIN

(71) Applicant: Rakeem Nunes, Kissimmee, FL (US)

(72) Inventor: Rakeem Nunes, Kissimmee, FL (US)

(21) Appl. No.: 16/794,310

(22) Filed: Feb. 19, 2020

(51) Int. Cl. B65F 1/14

(52) U.S. Cl. CPC B65F 1/14; B65F 2001/1653

(57) ABSTRACT

A garbage collection container device including a container member and a drain member. The container member stores collected garbage. The drain member is built into the container member for releasing elements therefrom. The drain member including an aperture, a drain valve, and a control mechanism for opening and closing the drain valve. The aperture and the drain valve are located at a first bottom region of the container member and the control mechanism is located at a second bottom region of the container member. The drain valve is opened in a drain operating mode to release the elements from the container member through the aperture and in a default operating mode the drain valve is closed and the aperture is sealed.

### FIELD OF THE INVENTION

Embodiments described herein generally relate to garbage collection containers, and more particularly to garbage collection containers with built-in drains.

### BACKGROUND OF THE INVENTION

Garbage containers are a major component of sanitation throughout the world, functioning for most as an ideal way to collect and then remove waste from surrounding environments. However, manually cleaning a trash receptacle requires a great deal of effort. Traditionally, washing a trash can requires a person to lift the trash can or tilt it to empty the receptacle. Since these trash cans are filled with water when washed, these receptacles are heavy and a hazard to lift or tilt. Hence, an improved way to wash a trash can is desired.

### BRIEF DESCRIPTION OF THE DRAWINGS

The various advantages of the embodiments of the present disclosure will become apparent to one skilled in the art by reading the following specification and appended claims, and by referencing the following drawing(s), in which:

FIG. 1 shows an exemplary view of a of a garbage collection container with built-in drain according to an embodiment of the present disclosure.

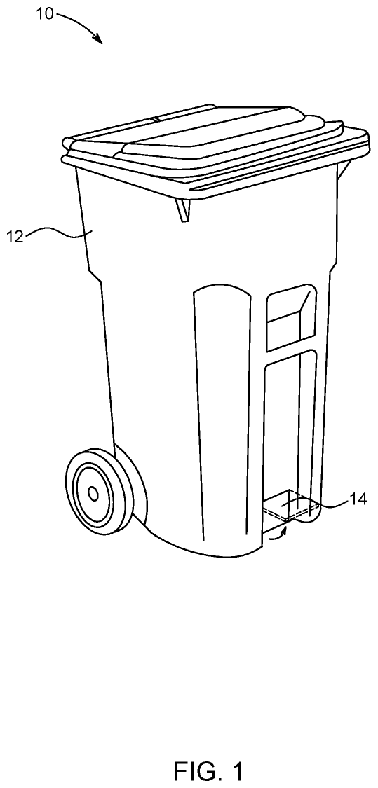

FIG. 2 shows another exemplary view of a garbage collection container with built-in drain according to an embodiment of the present disclosure.

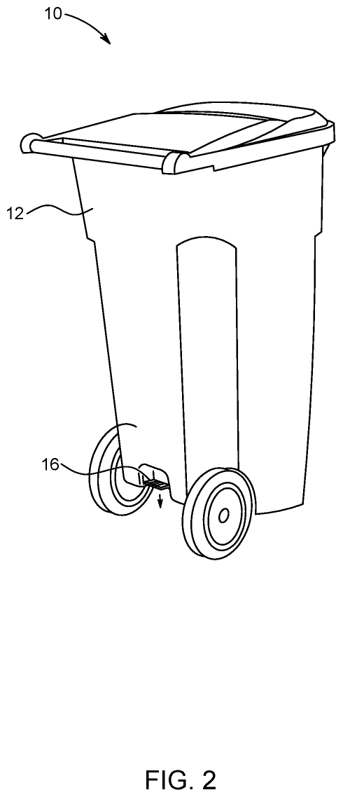

### SUMMARY OF THE INVENTION

Exemplary embodiments disclosed herein describe a garbage collection container device including a container member and a drain member. The container member stores collected garbage. The drain member is built into the container member for releasing elements therefrom. The drain member including an aperture, a drain valve, and a control mechanism for opening and closing the drain valve. The aperture and the drain valve are located at a first bottom region of the container member and the control mechanism is located at a second bottom region of the container member. The drain valve is opened in a drain operating mode to release the elements from the container member through the aperture and in a default operating mode the drain valve is closed and the aperture is sealed.

In some exemplary embodiments, the drain valve includes a hinged lid.

In some exemplary embodiments, the drain valve includes a spring.

In some exemplary embodiments, the control mechanism includes a foot-operated lever.

In some exemplary embodiments, the control mechanism includes a pedal.

In some exemplary embodiments, the valve is opened when pressure is applied to the foot-operated lever.

In some exemplary embodiments, the drain valve remains open as long as pressure is applied to the foot-operated lever.

In some exemplary embodiments, the bottom region of the container member is located on a front side of the container member.

In some exemplary embodiments, the second bottom region of the container member is located on a back side of the container member.

In some exemplary embodiments, the elements released from the container member include at least one or more from the group comprising residue, debris, sediments, dregs, and waste deposits.

In some exemplary embodiments, the device is operated in drain mode when washing of the device occurs.

### DETAILED DESCRIPTION

The present disclosure relates to a garbage collection container with a built-in drain device (“the device”). The device 10 includes a container member 12 for storing collected garbage and a drain member (includes 14 and 16). The drain member is built into the container member 12 for releasing elements therefrom. The drain member includes an aperture and a drain valve 14, and a control mechanism 16 for opening and closing the drain valve. The aperture and the drain valve 14 are located at a first bottom region of the container member. The first bottom region of the container is located on a front side of the container member.

The drain valve includes a hinged lid and a spring for opening and closing the drain valve. The drain valve is opened in a drain operating mode to release the elements from the container member through the aperture. The device operates in a drain mode when washing of the device occurs. The elements released from the container member include at least one or more from the group comprising residue, debris, sediments, dregs and waste deposits. In a default mode the drain valve is closed and the aperture is sealed.

The control mechanism 16 is located at a second bottom region of the container member 12, which is a back side of the container member 16. The control mechanism may include a foot-operated lever or pedal. When pressure is applied to the foot-operated lever or pedal, the drain valve is opened and the drain valve remains open as long as pressure is applied to the foot-operated lever or pedal.

Moreover, it should be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A garbage collection container device comprising:
a container member for storing collected garbage; and
a drain member built into the container member for releasing elements therefrom, the drain member including an aperture, a drain valve, and a control mechanism for opening and closing the drain valve, the aperture and the drain valve are located at a first bottom region of the container member and the control mechanism is located at a second bottom region of the container member, wherein the drain valve is opened in a drain operating mode to release the elements from the container member through the aperture and in a default operating mode the drain valve is closed and the aperture is sealed.

2. The device of claim 1, wherein the drain valve includes a hinged lid.

3. The device of claim 1, wherein the drain valve includes a spring.

4. The device of claim 1, wherein the control mechanism includes a foot-operated lever.

5. The device of claim 1, wherein the control mechanism includes a pedal.

6. The device of claim 4, wherein the drain valve is opened when pressure is applied to the foot-operated lever.

7. The device of claim 6, wherein the drain valve remains open as long as pressure is applied to the foot-operated lever.

8. The device of claim 1, wherein a first bottom region of the container member is located on a front side of the container member.

9. The device of claim 1, wherein a second bottom region of the container member is located on a back side of the container member.

10. The device of claim 1, wherein the elements released from the container member include at least one or more from the group comprising residue, debris, sediments, dregs, and waste deposits.

11. The device of claim 1, wherein the device is operated in drain mode when washing of the device occurs.
